(19) United States
(12) Patent Application Publication
(10) Pub. No.: US 2005/0160880 A1
(43) Pub. Date: Jul. 28, 2005

(54) Wrenching unit

(76) Inventors: Joerg E. Schulze-Beckinghausen, Garbsen (DE); Bernd-Georg Pietras, Wedemark (DE); Joerg Langer, Hannover (DE)

Correspondence Address: MOSER, PATTERSON & SHERIDAN, L.L.P., 3040 POST OAK BOULEVARD, SUITE 1500, HOUSTON, TX, 77056-6582, US

(21) Appl. No.: 10/765,567

(22) Filed: Jan. 27, 2004

(51) Int. Cl. B25B 13/50; B25B 17/00

(52) U.S. Cl. 81/57.34

(57) ABSTRACT

The present invention generally provides an apparatus for handling tubulars. In one aspect, the present invention provides a wrenching head for supplying torque over a large step less clamping range for connecting tubulars. In one embodiment, the wrenching head includes hydraulic clamping cylinders guided by pendulum bolts. The pendulum bolts prevent the piston from twisting or bending under a high clamping force. In another embodiment, the present invention provides a wrenching head having adjustable jaw units. The jaw units comprise a shaft threadedly connected to a jaw body. The jaw body includes a gear profile formed on an outer surface. A turn ring having a gear profile for mating with the gear profiles of the jaw body may be rotated to cause all of the jaw units to adjust simultaneously. In another aspect, the present invention provides a suspension unit to couple a spinner to the wrenching unit.

### BACKGROUND OF THE INVENTION

1. Field of the Invention

The present invention relates to apparatus for making up and breaking out tubular connections. Particularly, the present invention relates to a wrenching unit for making and breaking threaded connections between tubulars.

2. Description of the Related Art

Oilfield tubulars such as drill pipe and casing are employed in sections which are joined together at their ends by threaded connections. Typically, power tools are used to couple (“make up”) or decouple (“break out”) threaded connections. Power tools such as a bucking unit have been developed to threadably secure tubulars together.

A bucking unit or wrenching unit generally includes a power tong and a backup tong. The power tong is associated with a power drive to grip and apply torque to a first tubular to cause it to rotate. The backup tong is adapted to grip second tubular during engagement between the tubulars. The backup tong typically maintains the second tubular in a stationary position, thereby allowing relative rotation between the first and second tubulars. The backup tong may also allow some radial or axial displacement between the tubulars to accommodate deviations between the shapes of the tubulars during makeup.

The power tools generally used to connect tubulars are adapted and designed to provide the appropriate torque to achieve proper threaded connection. The threads may become damaged or stripped when excessive force is applied. Typically, the power tongs are provided with torque gauges to prevent damage to the threads. In many arrangements, hydraulic power is used to operate the power tool.

In one application, the bucking unit may be used to secure a coupling collar to a casing. Initially, the collar is engaged manually to one end of the casing, which is held in place by the backup tong. Thereafter, the power tong grips the collar and rotates the collar to complete the makeup. The casing and the collar may be stored for eventual makeup with other casings. Typically, only one end of the casing is fitted with a collar. A string of casings may be made up at the wellhead by engaging the free end of one casing to the collar attached on another casing.

In one known wrenching unit, the tubulars are clamped by hydraulic cylinders. Dies are fixed to the piston rods of the clamping cylinders. In operation, applied forces are transferred by the round guide bushing of the hydraulic cylinder. In some instances, the bushing and the seals of the hydraulic cylinders may be damaged when high torque is applied to a small diameter tubular. Because the dies are fixed to the piston rod, the piston rod will twist when a high clamping forces is applied. To prevent twisting, a key is disposed inside the clamping cylinder. However, adding the key weakens the piston rod and is expensive.

Many wrenching units are inefficient when used with different diameter tubulars. For example, some units are suitable only for a small range of diameters of pipes and limited in torque applying capacity. Thus, these units require the jaws to be replaced when a different diameter pipe is used. Because the jaws are bulky and heavy, the process of changing the jaws is time consuming and expensive.

There is a need, therefore, for a bucking or wrenching unit capable of supplying high torque over a large step less clamping range. There is also need for a wrenching unit to effectively transfer torque. There is a further need for a wrenching unit to transfer torque without damaging the clamping cylinders or hydraulic seals.

### SUMMARY OF THE INVENTION

The present invention generally provides an apparatus for handling tubulars. The apparatus includes a housing for receiving the tubular and a plurality of gripping members disposed in the housing for gripping the tubular. The apparatus further includes a plurality of torque distributors disposed in the housing for engaging the plurality of gripping members. In this respect, the torque distributors guide the gripping members to prevent twisting or bending. In this manner, damage to the gripping members is minimized.

In another aspect, the present invention provides a wrenching head for supplying torque over a large step less clamping range for connecting tubulars. In one embodiment, the wrenching head includes hydraulic clamping cylinders guided by pendulum bolts. The pendulum bolts prevent the piston from twisting or bending under a high clamping force. As a result, the hydraulic cylinders may be extended or retracted to handle tubulars of varying sizes.

In another aspect, the present invention provides a wrenching unit for connecting tubulars. The wrenching unit may comprise a frame, a first gripping apparatus disposed on the frame, and a second gripping apparatus disposed on the frame. The first gripping apparatus may include a housing for receiving the tubular and a plurality of gripping members disposed in the housing for gripping the tubular. In one embodiment, the first gripping apparatus may include a plurality of torque distributors disposed in the housing for distributing forces acting on the plurality of gripping members. In another embodiment, the plurality of gripping members may be adjusted to accommodate tubulars of varying sizes. Preferably, the plurality of gripping members is adjusted simultaneously.

In another aspect, the present invention provides a wrenching head having adjustable jaw units. In one embodiment, the jaw units comprise a shaft threadedly connected to a jaw body. The jaw body includes a gear profile formed on an outer surface. The wrenching head also includes a turn ring having a gear profile for mating with the gear profiles of the jaw body. In this respect, rotation of the turn ring causes all of the jaw units to adjust simultaneously.

The present invention provides a method for handling a tubular. Before the tubular is engaged by the gripping members of a gripping apparatus, the gripping members are adjusted to accommodate the size of the tubular. Preferably, the gripping members are adjusted at the same time. After the tubular is engaged by the gripping members, and torque is applied to the gripping apparatus. The torque is transferred to the gripping members, thereby rotating the engaged tubular.

In another aspect, the present invention provides a suspension unit for retaining a spinner to connect tubulars. The suspension unit may include one or more levers for coupling to the suspension unit to the spinner, wherein the spinner is allowed to move freely to align the tubulars during makeup. The suspension unit may be adapted to equalize the reaction torque transferred from the spinner. The suspension unit may also include a vertical lever for compensating for a weight of the spinner. In another embodiment, the suspension unit may be connected to a wrenching unit, thereby coupling the spinner to the wrenching unit.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a side view of the wrenching unit according to aspects of the present invention.

FIGS. 1B-C are front and back views of the wrenching unit of FIG. 1A. As shown, the wrenching unit is in the actuated position.

FIGS. 2A-C are front, side, and back views of the wrenching member of the wrenching unit.

FIG. 3 is a cross-sectional view of the wrenching head.

FIG. 4A is a perspective view of the gripping member of the wrenching head.

FIG. 4B is a cross-sectional view of the gripping member.

FIG. 5 depicts the wrenching member in the unactuated position.

FIG. 6 depicts the wrenching head engaging a large diameter tubular.

FIG. 7 depicts the wrenching head engaging a small diameter tubular.

FIG. 8 depicts a gripping member being removed from or inserted into the housing.

FIG. 9 shows an embodiment of a housing according to aspects of the present invention.

FIG. 10 shows an embodiment of a spinner and a suspension unit coupled to a wrenching unit.

FIG. 11 shows various views of an embodiment of a spinner.

FIG. 12 shows a suspension unit coupled to a wrenching unit.

FIG. 13 illustrates an embodiment of a suspension unit.

FIG. 14 illustrates partial sectional views of the suspension unit of FIG. 13.

FIG. 15 illustrates a side view of the suspension unit of FIG. 13.

FIG. 16 shows an embodiment of the suspension unit having a load indicator.

FIG. 17 shows an embodiment of the suspension unit having an extension member.

FIG. 18 shows a partial view of the suspension unit.

FIG. 19 is a perspective view of the wrenching head according aspects of the present invention disposed in a rotary of a wrenching unit. The wrenching head is shown with a transport device attached.

FIG. 20 depicts the wrenching head disposed in a rotary.

FIG. 21A is a top view of the wrenching head in a retracted position. A portion of the wrenching head is shown in cross-section.

FIG. 21B is a top view of the wrenching head in FIG. 21A in an extended position.

FIG. 22A is a side view of the wrenching head of FIG. 21A.

FIG. 22B is a side view of the wrenching head of FIG. 21 B.

FIG. 23 illustrates the gripping members with the gear ring in the retracted position.

FIG. 24 illustrates the gripping members in an extended position. Also shown is the indexing assembly disposed on a gripping member.

FIG. 25 illustrates a gripping member in the extended position.

FIG. 26 illustrates the wrenching head equipped with the transport device.

### DETAILED DESCRIPTION OF THE PREFERRED EMBODIMENT

I. Torque Resistant Wrenching Unit

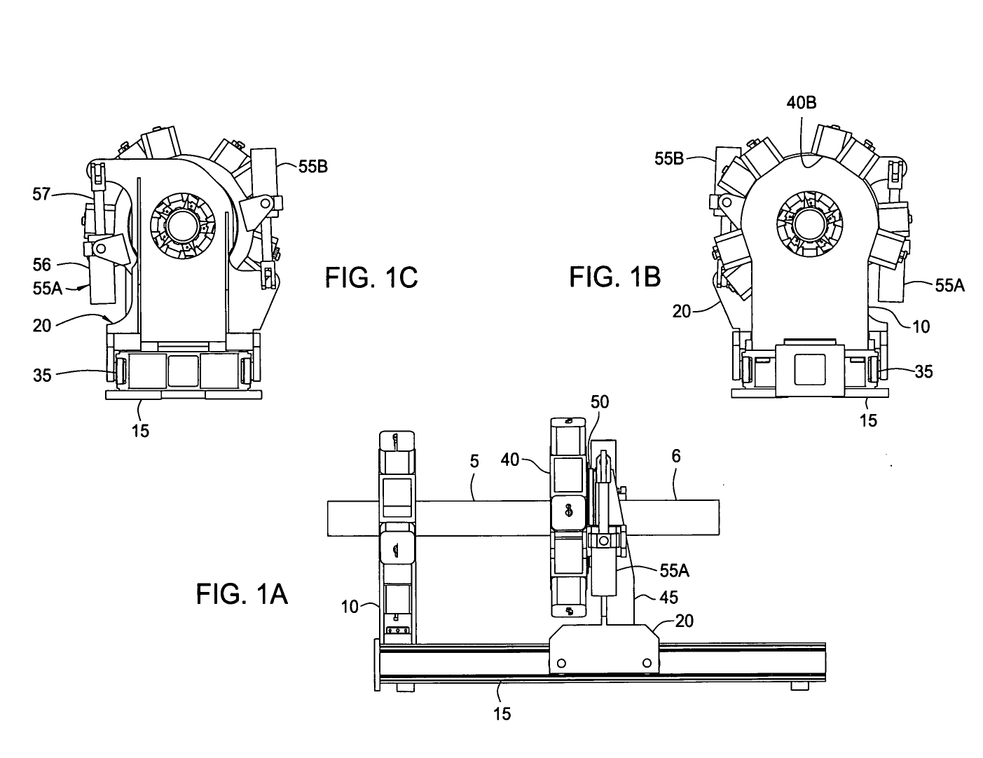

The present invention relates to an apparatus for making up and breaking out tubulars. In one embodiment, a wrenching unit 100 includes a frame 15, a first gripping apparatus 10, and a second gripping apparatus 20. As shown in FIGS. 1A-C, the first gripping apparatus 10 may be a backup gripper 10 fixed on one end of the frame 15, while the second gripping apparatus 20 may be a wrenching member 20 that is movably disposed on the other end of the frame 15. The wrenching member 20 includes one or more wheels 35 adapted to move the wrenching member 20 along the frame 15 relative to the backup gripper 10 to accommodate or adjust for changes in the distance therebetween. It must be noted that either or both of the gripping apparatus 10, 20 may be wrenching members or movably disposed on the frame 15.

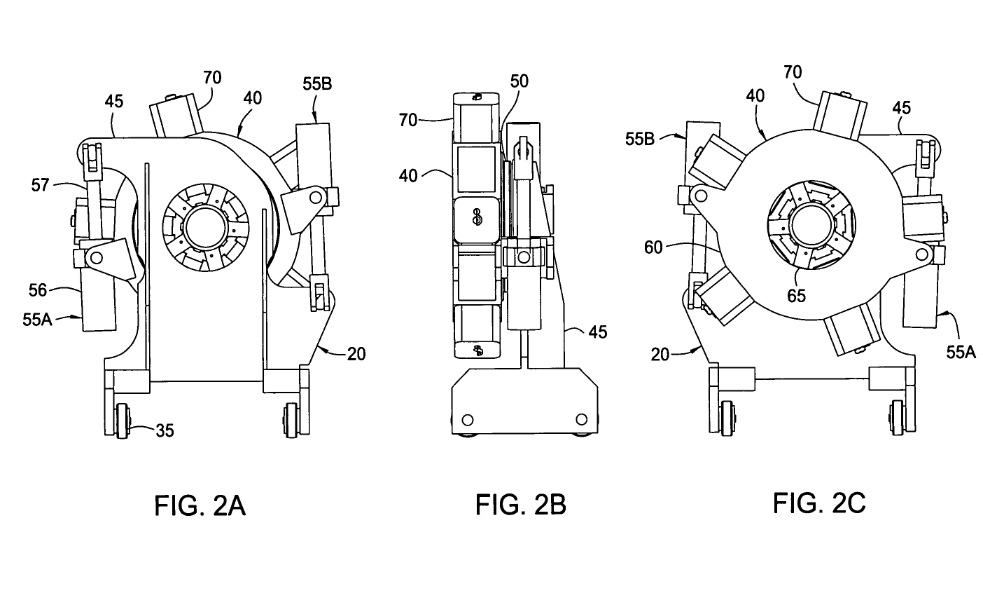

FIGS. 2A-C depict the respective front, side, and back views of the wrenching member 20 in the extended position. In one aspect, the wrenching member 20 includes a wrenching head 40 movably connected to a mounting plate 45. Particularly, a slewing ring 50 or roller bearings are disposed between the wrenching head 40 and the mounting plate 45 to facilitate rotation therebetween. The wrenching head 40 may be rotated using one or more torquing members 55. As shown, torquing members 55 in the form of a pair of piston and cylinder wrenching assembly 55A, 55B are rotatably connected between the wrenching head 40 to the mounting plate 45. Preferably, the cylinders 56 are attached to the wrenching head 40 and the pistons 57 are attached to the mounting plate 45. In one embodiment, the torquing members 55 are pivotably attached to the mounting plate 45 and the wrenching head 40 to facilitate relative rotation during operation. The torquing members 55 may be adapted to rotate the wrenching head 40 up to about 45 degrees relative to the mounting plate 45. More preferably, the torquing members 55 are adapted to rotate the wrenching head 40 between about 15 degrees and about 40 degrees, and most preferably, between about 25 degrees and about 35 degrees. In this manner, the torquing members 55 may apply torque to the wrenching head 40, which, in turn, transfers the torque to the tubular 6 being held.

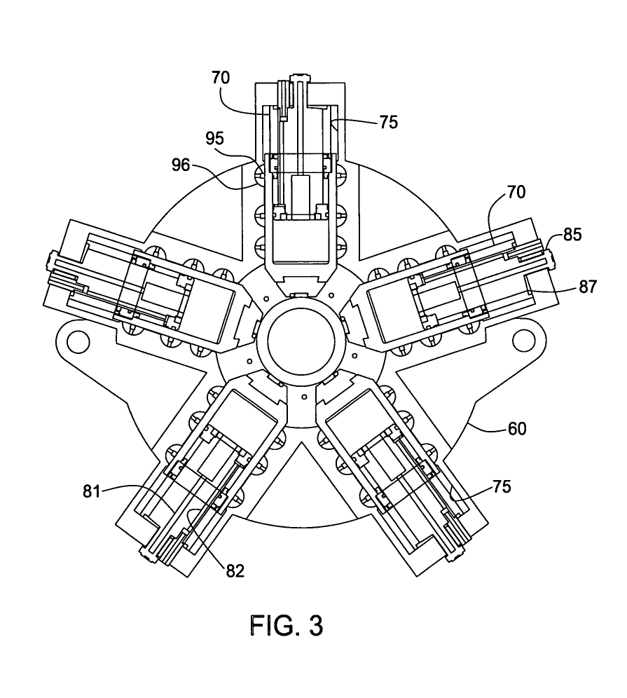

The wrenching head 40 includes a housing 60 having a plurality of gripping members 70. A hole 65 is formed in the housing 60 to accommodate the tubular 6 to be handled by the gripping members 70. Each gripping member 70 is at least partially disposed in a respective chamber 75. FIG. 3 is a cross-sectional view of one embodiment of the present invention. As shown, the wrenching head 40 includes five gripping members 70 radially disposed in the housing 60 with respect to the center of the hole 65.

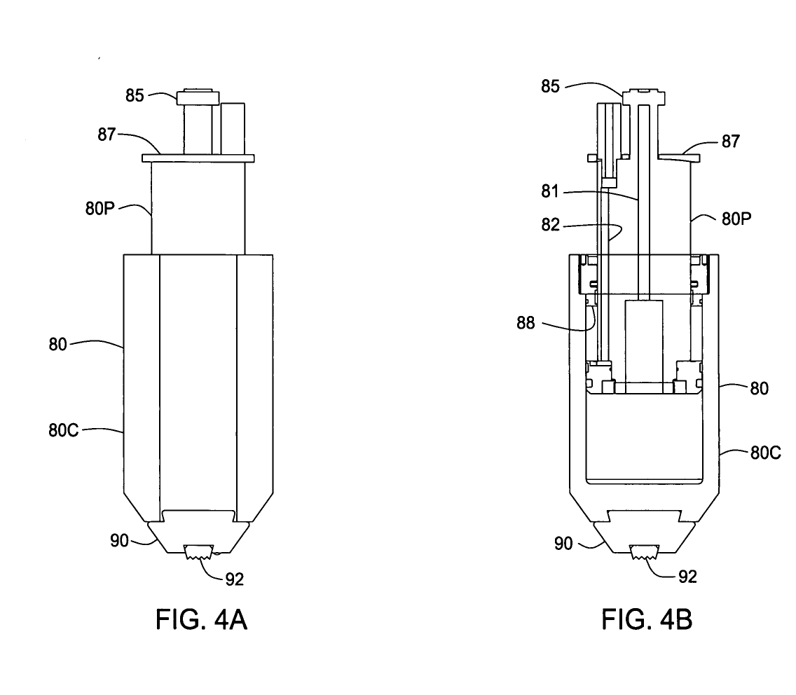

In one embodiment, the gripping member 70 includes a piston and cylinder clamping assembly 80. FIGS. 4A-B illustrates a gripping member 70 according to aspects of the present invention. The piston 80P may be fixed by a nut 85 to the wrenching head 40 as shown in FIG. 3. It must be noted that other types of locking mechanisms may be used as is known to a person of ordinary skill in the art. Once the piston 80P is fixed, the clamping cylinder 80C may be actuated to move radially relative to the piston 80P. A load plate 87 may be disposed between the piston 80P and the wrenching head 40. Preferably, the contact surfaces between the piston 80P and the load plate 87 are curved or arcuate in shape. The clamping cylinder 80C may also include a jaw 90 for retaining a die 92 to engage the tubular 6. In addition to the jaw 90 and the die 92, other types of engagement members known to a person of ordinary skill in the art are also contemplated.

In the preferred embodiment, the gripping member 70 is hydraulically actuated. The gripping member 70 may include an inlet 81 and an outlet 82 for directing the flow of the actuating fluid. According to aspects of the present invention, the gripping members 70 may be actuated to move simultaneously into engagement with the tubular 6. The synchronized movement of the cylinders 80C may be achieved by using a flow divider to supply the actuating fluid to the gripping members 70. Seals 88 may be used to prevent fluid leakage. Fluid pressure may be supplied to the gripping member 70 to cause the gripping member 70 to move into engagement with the tubular 6. The tubular 6 is engaged when a predetermined gripping pressure is reached. It is also contemplated that the gripping members 70 may be actuated in other manners known to a person of ordinary skill in the art, for example, pneumatic fluid or electrics.

In another aspect, the wrenching head 40 may include one or more torque distributors 95 to resist twisting during operation, as illustrated in FIG. 3. When the wrenching head 40 is driven by the torquing members 55 or wrenching cylinders, a large clamping force is applied to the jaws 90. As a result, the gripping members 70 will experience a torque that may cause the gripping members 70 to bend or twist. To alleviate this problem, portions of the chamber 75 are lined with torque distributors 95 to absorb the torque in the direction of the cylinder axis. In one embodiment, pendulum bolts 95 are disposed in the chamber 75 to guide the clamping cylinder's 80C radial movement. Particularly, the pendulum bolts 95 define a pin having an arcuate surface on one side and a substantially flat surface on another. The pendulum bolts 95 are placed in half bores 96 formed in the walls of the chamber 75. The flat surface of the pendulum bolts 95 provides large contact areas with the clamping cylinders 80C. The contact areas are independent from the position or force situation at the clamping cylinders 80C at all times. Due to the large contact areas, the surface contact pressure is very low, thereby increasing the longevity of the gripping members 70. In the embodiment shown in FIG. 3, each chamber 75 is equipped with six pendulum bolts 95. However, any number of torque distributors 95 may be used to optimize the wrenching unit 100. In another embodiment, instead of pendulum bolts 95, the torque distributors may comprise a rectangular plate made of thin spring steel. Similar to the pendulum bolts 95, the rectangular plates may be placed around the perimeter of the clamp cylinder 80C to guide the clamp cylinder's movement.

In the preferred embodiment, the backup gripper 10 is adapted to retain a tubular 5 in a stationary position, while the wrenching member 20 applies torque to another tubular 6 to connect the tubulars 5, 6. Referring to FIG. 1B, the backup gripper 10 includes a wrenching head 40B similar to the one on the wrenching member 20. One of the differences being that the wrenching head 40B is a fixed part of the backup gripper 10. However, it must be noted that a wrenching member 20 may also be used as a backup gripper 10.

In operation, the wrenching unit 100 of the present invention may be used to makeup or breakout two tubulars 5, 6. As shown in FIG. 1, two partially made up tubulars 5, 6 are held by the wrenching unit 100. Particularly, a first tubular 5, such as a casing, is handled by the backup gripper 10, and a second tubular 6, such as a coupling, is handled by the wrenching member 20.

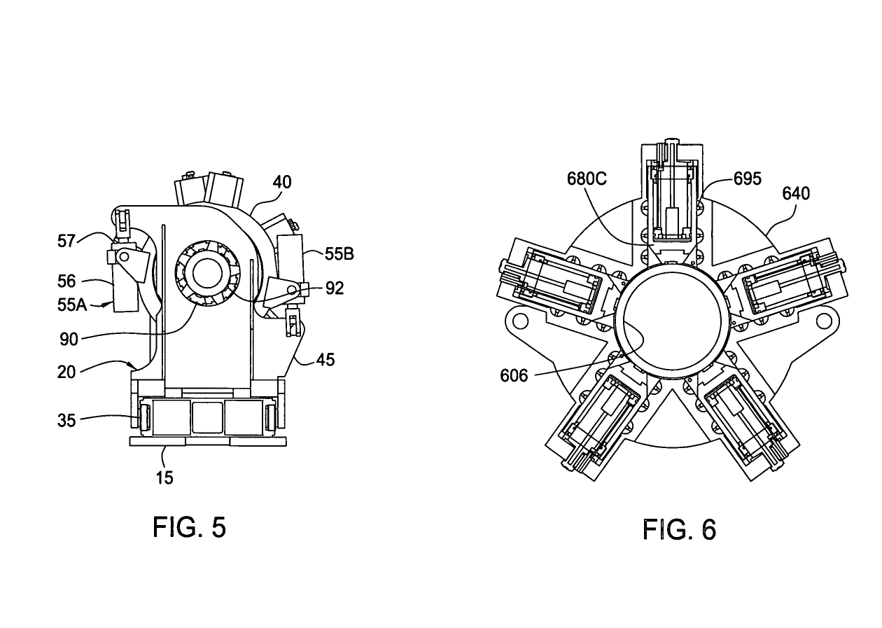

Initially, the wrenching head 40 of the wrenching member 20 is in the unactuated position as shown in FIG. 5. As shown, the wrenching member 20 is equipped with five gripping members 70, which have been retracted. Fluid pressure to the gripping members 70 is supplied equally to move the clamping cylinders 80C simultaneously. Initially, the fluid pressure extends the jaws 90 into contact with the tubular. Thereafter, additional fluid pressure is supplied to ensure engagement of the gripping members 70 with the tubular. The fluid pressure supplied is typically predetermined based on the characteristics of the tubular and the tubular connection. The actuation of the wrenching member 20 also applies to the backup gripper 10. It must be noted that the wrenching member 10 and the backup gripper 10 may have separate fluid supply lines so that different gripping pressures may be applied when necessary. After engagement, torque may be applied to makeup the tubulars.

In FIG. 5, the torquing members 55A, 55B are in the unactuated position. Particularly, the pistons 57 are in the retracted position relative to cylinders 56. Because the pistons 57 are connected to the mounting plate 45, actuation of the torquing members 55A, 55B causes the cylinders 56 to extend from the pistons 57. In turn, the wrenching head 40 is caused to rotate relative to the mounting plate 45 and the backup gripper 10. Consequently, the coupling 6 is rotated relative to the casing 5, thereby making up the connection, as illustrated in FIG. 1C.

As the torque is applied to the coupling 6, the gripping members 70 experience a circumferential force. In one embodiment, the wrenching unit 100 includes features that minimize the potential for the gripping member 70 to twist or bend. First, the jaw 90 is connected to the cylinder 80C, which has a larger outer diameter than the piston 80P. The larger diameter allows to the cylinder 80C to better resist twisting. Second, the arcuate contact surface between the piston 80P and the load plate 87 also aids in resisting a bending load. Third, the pendulum bolts 95 in the chambers 75 balances the forces acting on the clamping cylinder 80C. These features, acting alone or in combination, reduce the tendency for the gripping members 70 to twist or bend. As a result, the life of the gripping members 70 is prolonged.

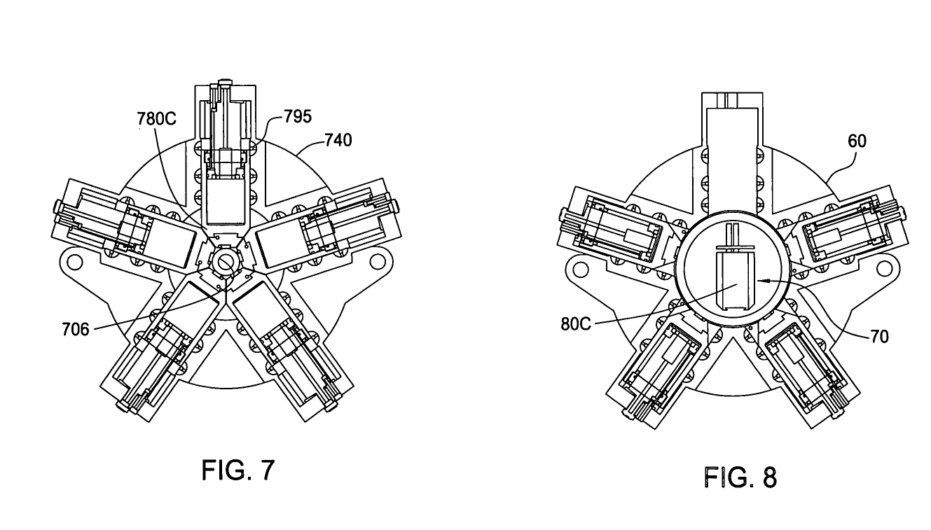

In another aspect, the wrenching unit 100 of the present invention is applicable over a large clamping range. The ability of the wrenching unit 100 to resist twisting or bending allows the wrenching unit 100 to be operated over a wide range of tubular diameters. FIG. 6 depicts the wrenching head 640 engaged with a large diameter tubular 606. It can be seen that each clamping cylinder 680C is guided by four pendulum bolts 695. In contrast, FIG. 7 depicts the wrenching head 740 engaged with a small diameter tubular 706. As shown, each clamping cylinder 780C is guided by six pendulum bolts 795. This versatility allows the wrenching unit 100 to be adjusted quickly to accommodate a different sized tubular.

In another aspect, the gripping members 70 are interchangeable and replaceable when necessary. As discussed above, the gripping member 70 is attached to the housing 60 using a nut 85 or other known locking mechanism. After the clamping cylinder 80C is retracted, the nut 85 may be decoupled from the piston 80P to release the gripping member 70 from the housing 60. Thereafter, the gripping member 70 may be removed through the center of the housing 60, as illustrated in FIG. 8.

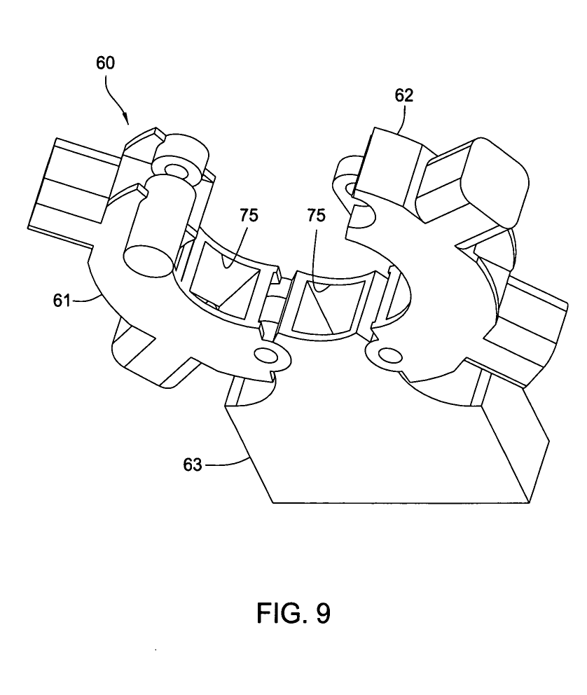

In another aspect still, the housing 60 may be adapted to open on a side during operation in order to receive a tubular from the top. In the embodiment shown in FIG. 9, the housing 60 comprises two arcuate portions 61, 62 pivotably coupled to a base 63 on one end. The other end of the arcuate portions 61, 62 may be locked to close the housing 60. As shown, each arcuate portion 61, 62 has two chambers 75 and the base 63 has one chamber 75 for retaining the gripping members 70.

II. Spinner and Suspension Unit

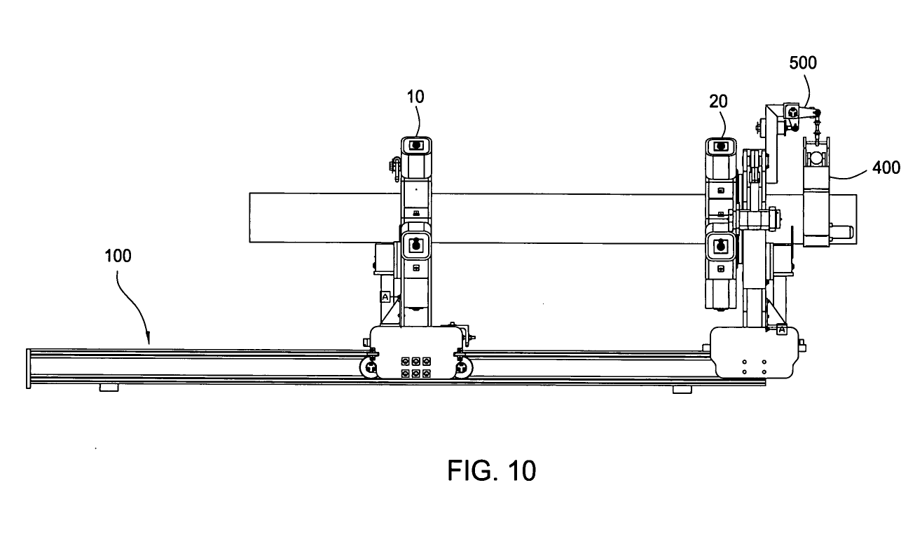

In another aspect, the present invention provides a spinner 400 and suspension unit 500 usable with the wrenching unit 100. FIG. 10 depicts an exemplary embodiment of a spinner 400 and suspension unit 500 disposed on the wrenching unit 100. A person of ordinary skill in the art will recognize that including the spinner with the wrenching unit will facilitate the tubular makeup process. The spinner may supply low torque to continuously rotate the tubular, while the wrenching head supplies high torque over a small angle to complete the make up process.

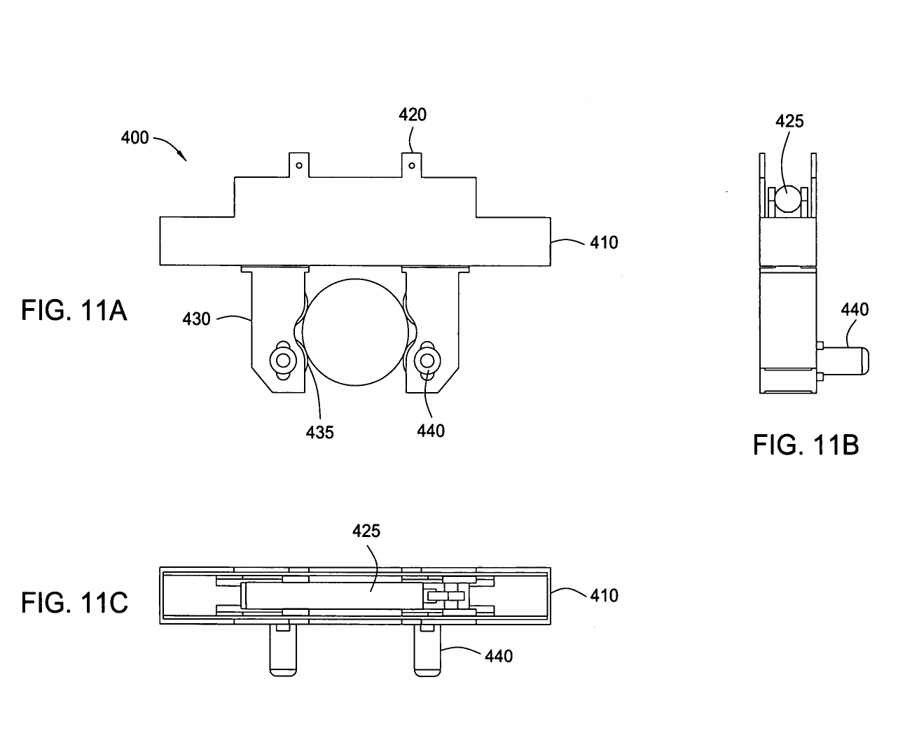

FIGS. 11A-C illustrate an exemplary embodiment of a spinner 400 contemplated by the present invention. The spinner 400 includes a body 410 and two hanging ears 420 for coupling to the suspension unit 500. The spinner also includes two arms 430 movable relative to each other. In one embodiment, the two arms 430 are actuated by a cylinder 425 and may be brought together to engage a tubular. The arms 430 house one or more rollers 435 for rotating the tubular at a relative high speed. Preferably, each arm 430 includes two rollers 435 which are actuated by a motor 440 coupled to each arm 430. The rollers 435 frictionally engage the tubular to transfer torque to the tubular. It must be noted that aspects of the present invention contemplates using other types of spinners known to a person of ordinary skill in the art.

Generally, several difficulties may be encountered when adapting the spinner 400 for use with the wrenching unit 100. First, the center of the spinner 400and the backup gripper 10 may not be aligned. The misalignment may damage the threads during make up. Second, the imperfections in the roundness of the tubular may cause the spinner 400 to vibrate during rotation. Third, the spinner 400 should be able to follow the axial thread movement during makeup. Fourth, because the spinner 400 produces torque, the reaction torque at the spinner 400 must be equalized. In summary, a supporting system for the spinner 400 should be adapted to carry the weight of the tubular, balance the reaction torque, and follow the axial movement of the tubular.

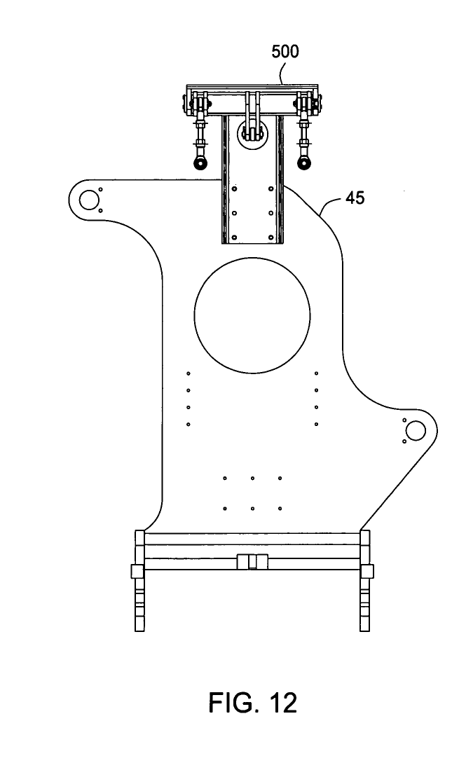

Aspects of the present invention provide a suspension unit 500 for adapting the spinner 400 for use with the wrenching unit 100. Referring back to FIG. 10, the suspension unit 500 is attached to the wrenching unit 100 and is shown supporting the spinner 400. Particularly, the suspension unit 500 is connected to the mounting plate 45 of the wrenching member 20 as shown in FIG. 12.

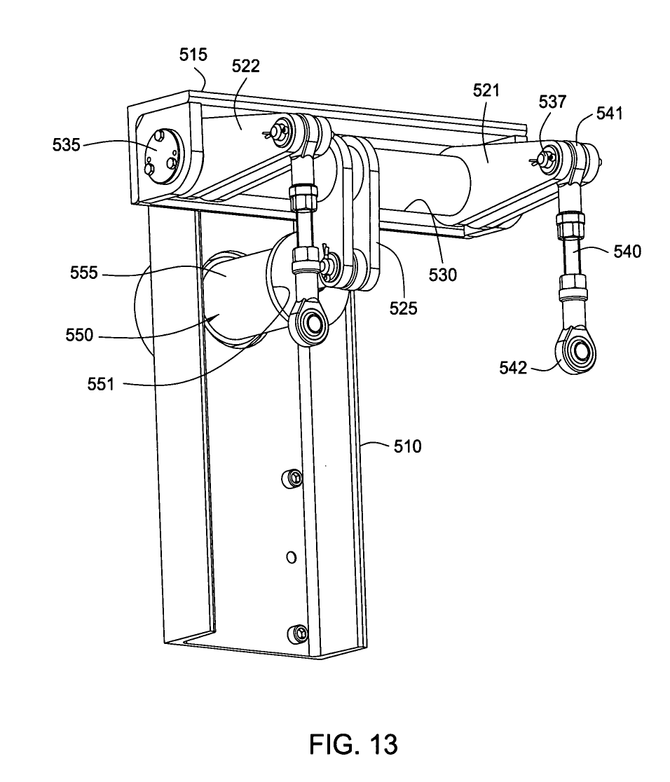

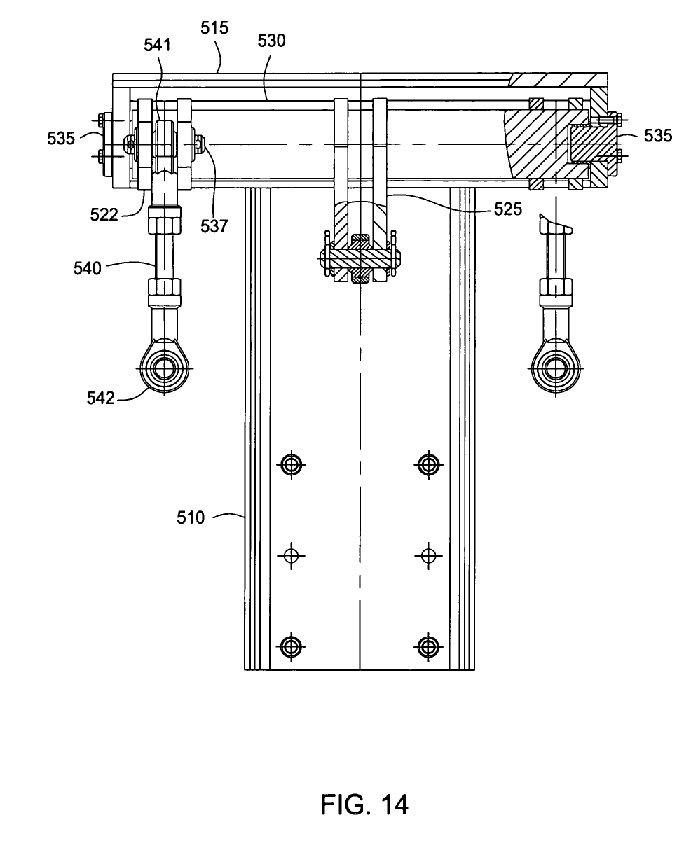

FIG. 13 shows an exemplary suspension unit 500 according to aspects of the present invention. The suspension unit 500 includes a mounting member 510 for attaching to the wrenching unit 100 and a support member 515 for coupling the levers 521, 522, 525 to the mounting member 510. In one embodiment, a torque beam 530 is attached to the support member 515 using one or more bolts 535. The torque beam 530 is connected to lever arms 521, 522 for supporting the spinner 400. As shown in FIG. 14, two lever arms 521, 522 are attached near the ends of the torque beam 530. Each lever arm 521, 522 is movably coupled to attachment rods 540 having ball and socket joints 541, 542 at either end. Preferably, the ball and socket joints 541, 542 at either ends are rotated 90 degrees from each other. One end 541 of the attachment rod 540 is movably coupled to the lever arm 521 using a bolt 537. Similarly, the other end of the attachment rod 540 is coupled to the ear 425 of the spinner 400.

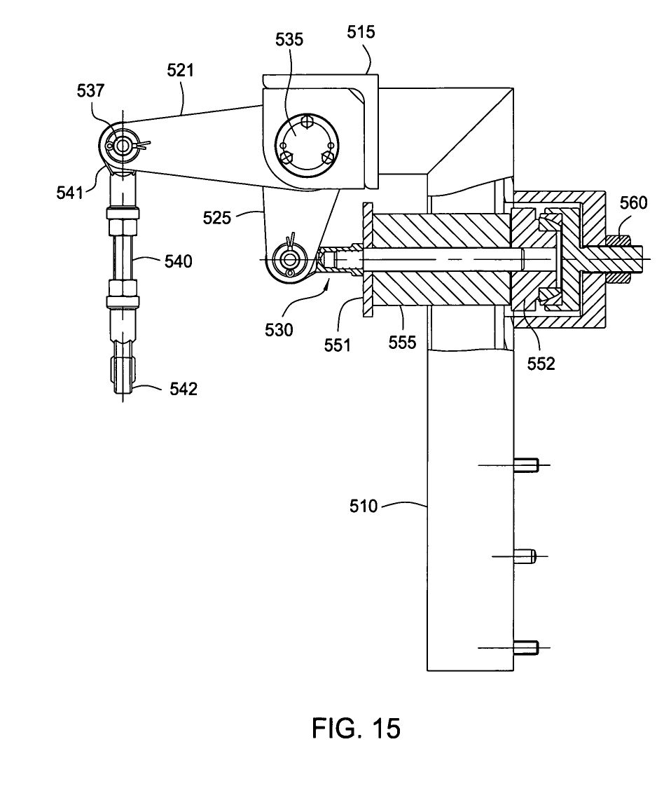

As shown in FIG. 13, a vertical lever 525 is attached to the torque beam 530. The distal end of the vertical lever 525 is coupled to a biasing member 550. The biasing member 550 may include a spring 555 disposed between two thrust plates 551, 552, as shown in more detail in FIG. 15. Particularly, the thrust plate 551 at one end is coupled to the vertical lever 525. The thrust plate 552 at the other end is attached to a nut and bolt assembly 560. The nut and bolt assembly 560 may be manipulated to adjust the height of the lever arms 521, 522.

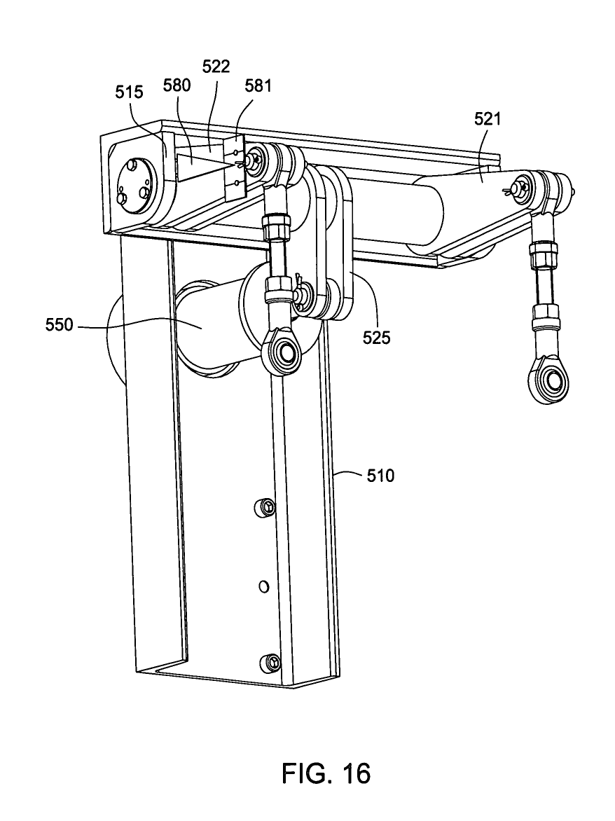

In operation, the suspension unit 500 allows the free floating of the spinner 400 in all directions. Specifically, the ball and socket joints allows the spinner 400 to move freely, while allowing only torque to be transferred from the spinner 400 to the suspension unit 500. In this respect, the spinner 400 may move freely to align itself with the backup gripper 10. However, the suspension unit 500 remains stiff against the torque transferred, thereby reducing vibration on the wrenching unit 100. Additionally, vertical forces such as the weight of the spinner 400 may be compensated by the vertical lever 525. Specifically, the vertical force will act against the thrust plate 551 and compress the spring 555. The length of the compression of the spring 555 may be measured to determine the load on the suspension unit 500. Alternatively, an indicator 580 and a scale 581 may be installed to indicate the load, as illustrated in FIG. 16. Specifically, the indicator 580 may be attached to the support member 515, and the scale may be attached to the lever arm 522.

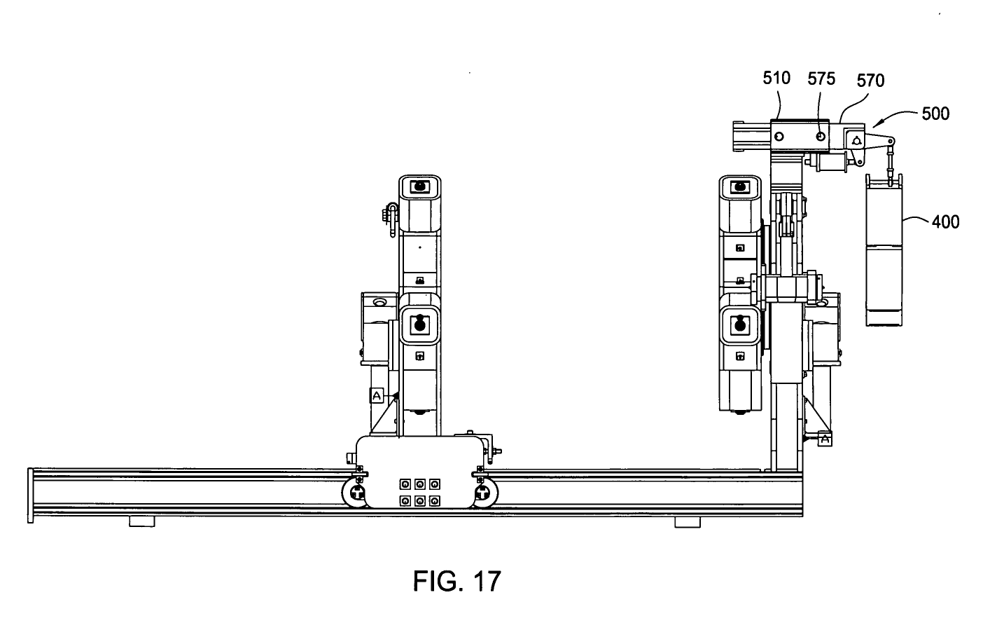

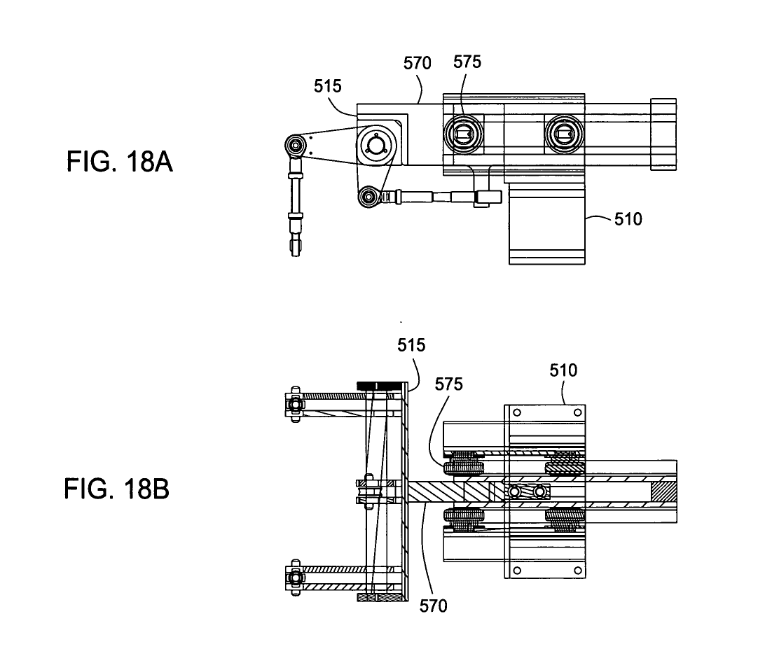

In another embodiment, the suspension unit 500 may be adapted to accommodate the change in axial length of the tubular as the thread is made up. As shown in FIGS. 17 and 18, the support member 515 may be adapted to extend or retract relative to the mounting member 510. Particularly, the support member 515 may include an extension member 570 coupled to rollers 575 disposed on the mounting member 510. Preferably, the extension member 570 is supported by two pairs of rollers 575. In this manner, the support member 515 may be retracted relative to the mounting member 510 as the threads are made up.

III. Wrenching Unit with Simultaneously Adjustable Gripping Members

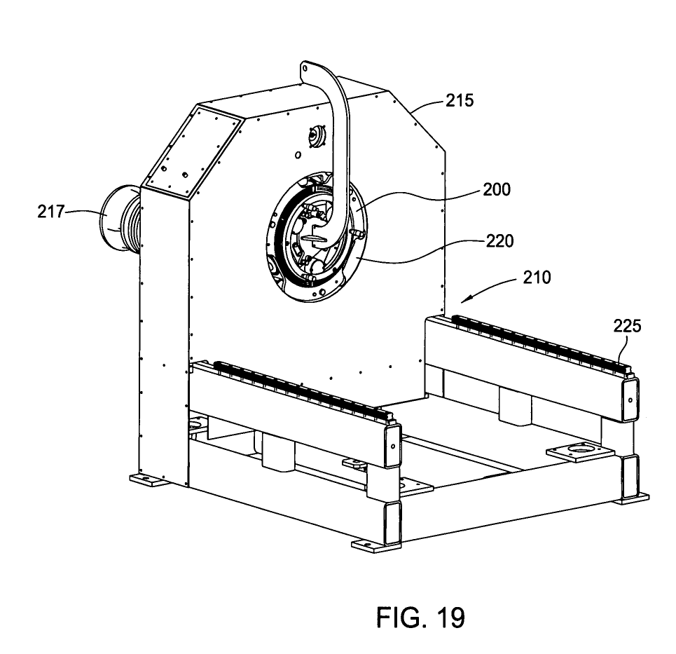

In another aspect, the present invention relates to a wrenching head 200 for assembling tubulars. FIG. 19 shows a wrenching unit 210 for making up and breaking out tubulars. The wrenching unit 210 includes a frame 225 and a powered gripping apparatus 215. The powered gripping apparatus 215 includes a motor 217 for applying torque to a tubular. The backup gripping apparatus is not shown for clarity. However, it must be noted that the backup gripping apparatus may include any suitable gripping apparatus known to a person of ordinary skill so long as it is capable of retaining a tubular for connection with the tubular in the powered gripping apparatus 215. Nevertheless, the backup gripping apparatus may also have torquing ability or movable on the frame 225.

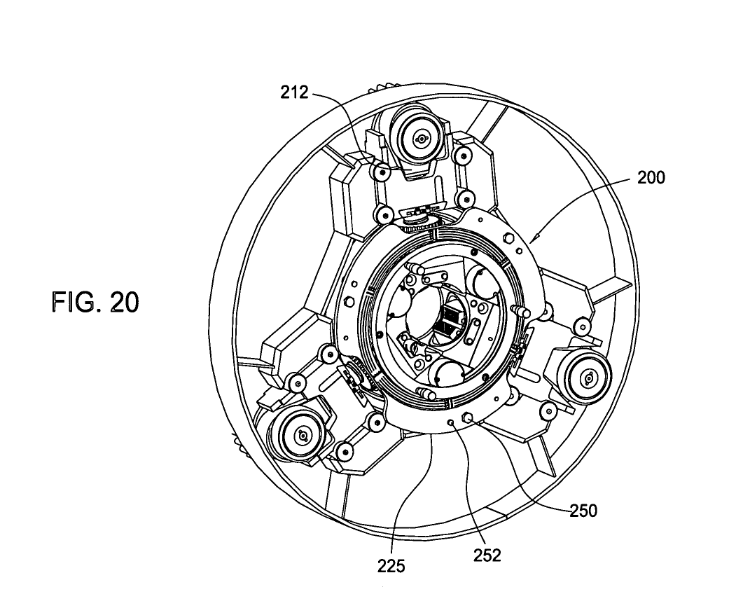

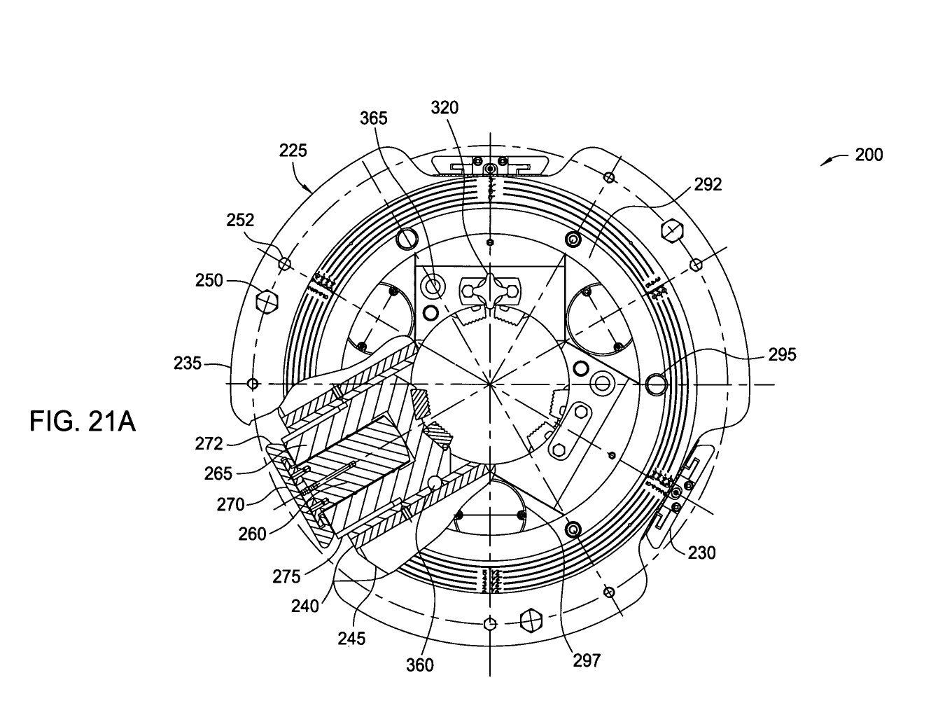

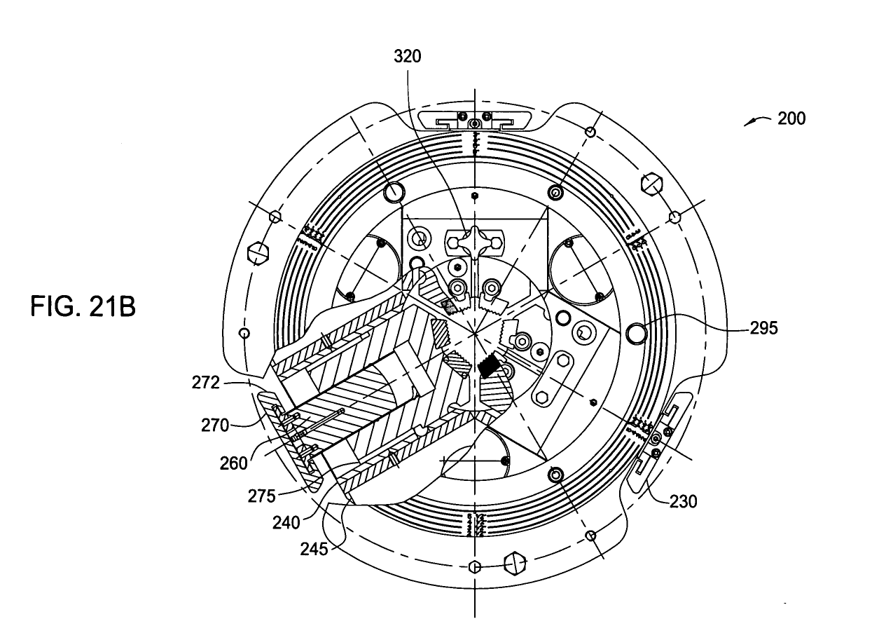

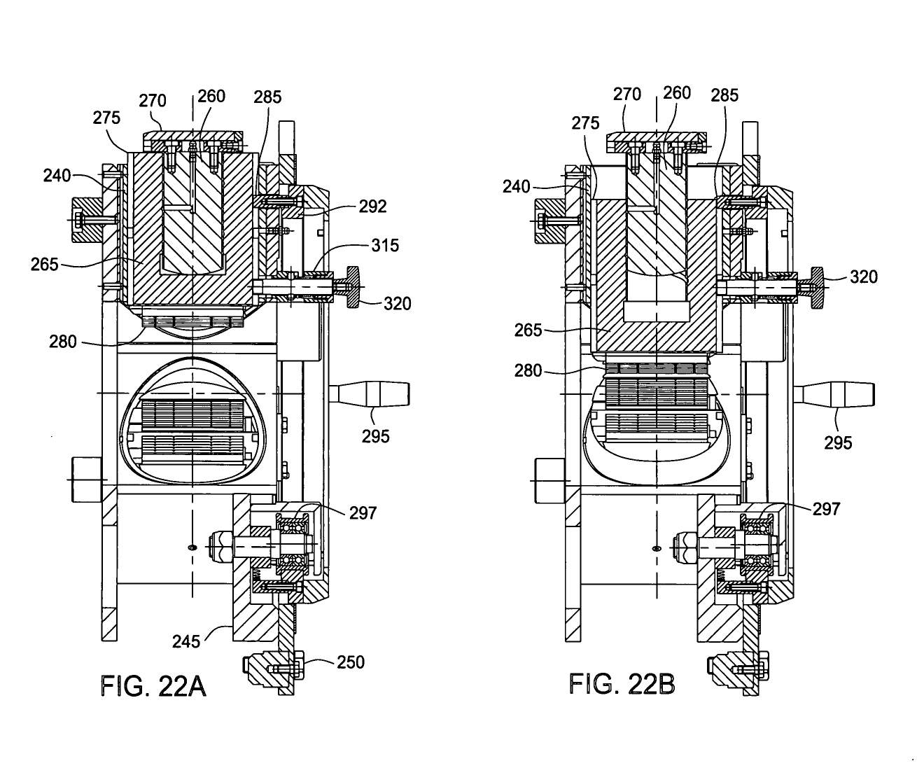

In one aspect, the present invention provides a gripping head 200 for use with a rotary 220. As illustrated in FIG. 20, the gripping head 200 is installed in the rotary 220 of the powered gripping apparatus 215. In the embodiment shown in FIG. 21A-B, the gripping head 200 includes a housing 225 and a plurality of gripping members or jaws 230. The housing 225 of the gripping head 200 is adapted to fit in the rotary 220. The housing 225 comprises a mounting plate 235, a plurality of jaw blocks 240, and a plurality of base plates 245. The mounting plate 235 may be used to attach the gripping head 200 to the rotary 220. As shown, the housing 225 is attached to the rotary 220 using one or more bolts or screws 250. Dowell rods 252 may be also be used in combination with the bolts 250. FIGS. 22A-B depict side views of the gripping head 200 of FIGS. 21A-B, respectively.

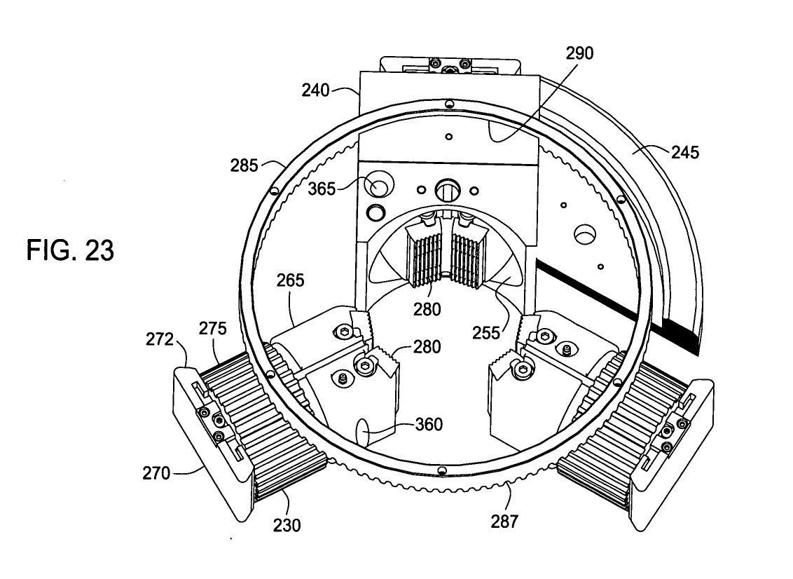

Each jaw block 240 includes a bore 255 for maintaining a jaw 230 as seen in FIG. 23. The jaw blocks 240 are connected using base plates 245. As shown, three jaws 230 are radially disposed in the housing 225. The back of the jaws 230 are in contact with the connecting rods 212 in the rotary 220. Actuation of the connecting rods 212 causes the jaws 230 to move radially.

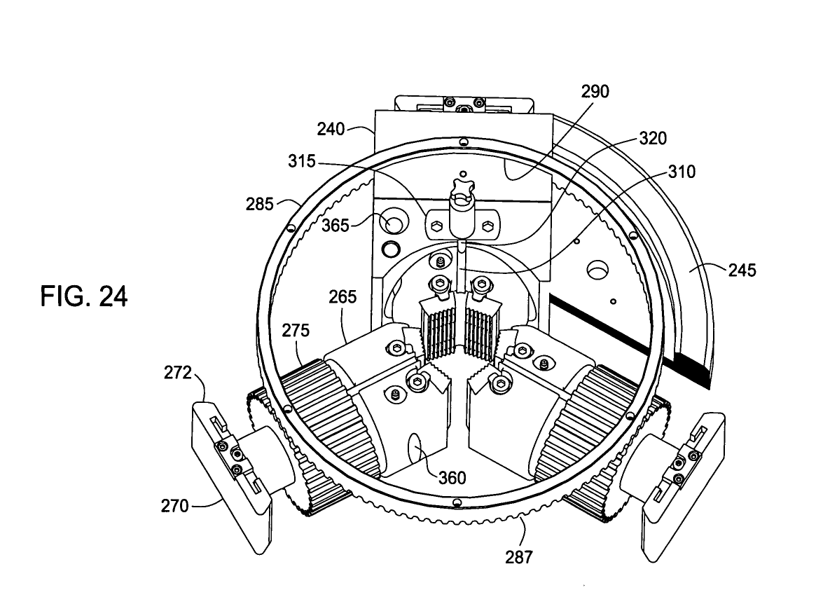

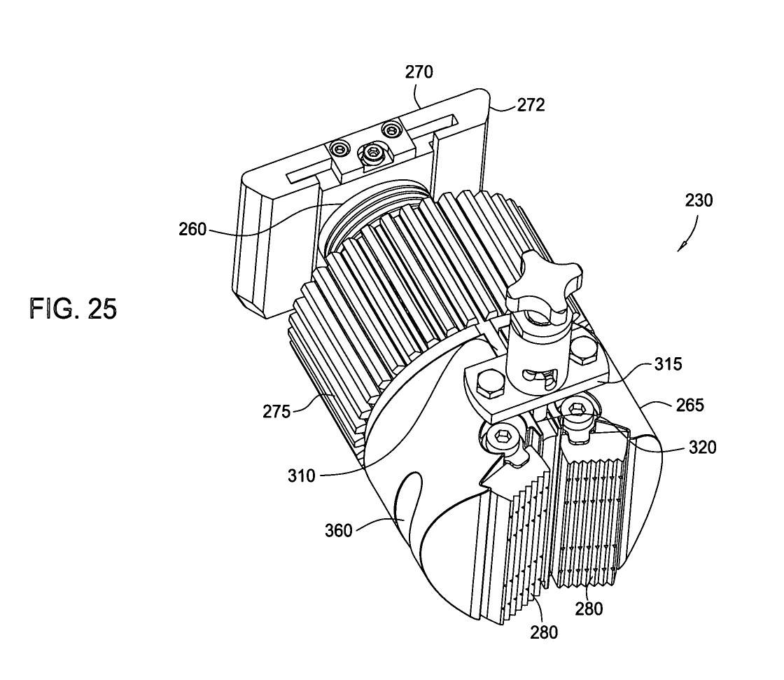

According to aspects of the present invention, the gripping members 230 are adjustable in length. FIG. 23 shows the gripping members 230 in a retracted position, and FIG. 24 shows the gripping members 230 in an extended position. In the embodiment shown in FIG. 25, each gripping member 230 comprises a jaw body 265 having a shaft 260 partially inserted through one end of the jaw body 265. The shaft 260 and the jaw body 265 being threadably connected. A shaft head 270 for contacting the connecting rod of the rotary 220 may be disposed at one end of the shaft 260 and jaw body 265 assembly, while one or more dies 280 may be disposed at the opposite end of the assembly. When disposed in the rotary 220, the counter dovetail profile 272 of the shaft head 270 prevents the shaft 260 from rotating about its longitudinal axis. An exterior portion of the jaw body 265 may include a gear profile 275. Preferably, the gear profile 275 is formed in a manner allowing the jaw body 265 to move radially during operation. Because the shaft head 270 is rotationally fixed, actuation of the gear profile 275 causes the jaw body 265 to rotate relative to the shaft 260 in accordance with the threaded connection therebetween. As a result, the jaw body 265 may be extended (retracted), thereby increasing (decreasing) the length of the gripping member 230.

In another aspect, the gripping members 230 may be adapted to adjust simultaneously and equally. In one embodiment, a gear ring 285 may be used to simultaneously actuate the jaws 230, illustrated in FIGS. 23 and 24. Particularly, the gear ring 285 has a gear profile 287 on one surface for mating with the gear profiles 275 of the jaw bodies 265. As the ring 285 is rotated, all of the gear profiles 275 on the jaw bodies 265 are actuated simultaneously, thereby extending the jaw body 265 equally. Preferably, a ring groove 290 is formed in the jaw block 240 for accessing the gear profile 275 of the jaw body 265, as shown in FIG. 23. The gear ring 285 may include a turn ring 292 having handles 295 for rotating the gear ring 285, as illustrated in FIGS. 21 and 22. In another embodiment, the handles 295 may be disposed directly on the gear ring 285. In addition, one or more rollers 297 are used to facilitate rotation of the gear ring 285. Preferably, a roller 297 is disposed on each base plate 245 to guide the gear ring 285.

In another aspect, one or more indexing slots 310 may be formed on the exterior of the jaw body 265. Referring now to FIGS. 24 and 25. The indexing slots 310 are adapted to orient the dies 280 to facilitate proper engagement of the dies 280 with the tubular. Preferably, two indexing slots 310 disposed at 180 degrees apart from each other are formed on the outer surface of the jaw body 265. In one embodiment, a collar base 315 is attached to the jaw block 240. The indexing key 320 may be inserted through the collar base 315 to engage the indexing slot 310. When necessary, the indexing key 320 may be pulled out of the indexing slot 310 to allow the jaw body 265 to rotate, thereby adjusting its length. After the proper length is obtained, the indexing key 320 is inserted back into the indexing slot 310 to ensure proper alignment of the dies 280 with the tubular. Preferably, radial movement of the jaw body 265 is still possible when the indexing key 320 is engaged with the indexing slot 310.

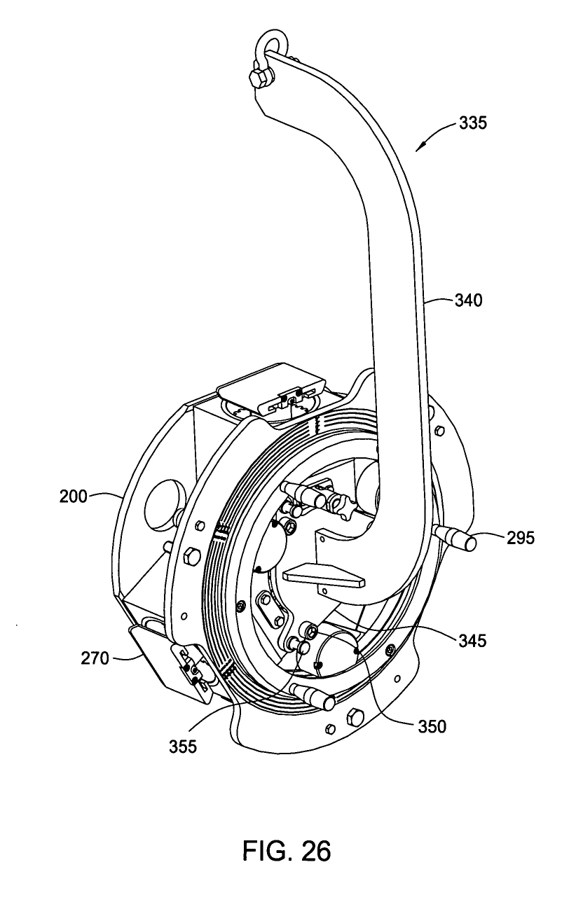

The gripping head 200 of the present invention includes features to facilitate installation and transportation thereof. As noted above, a transport device 335 may be used to install or remove the gripping head 200. FIG. 26 shows the transport device 335 attached to the gripping head 200. In one embodiment, the transport device 335 includes an arm portion 340 and an attachment portion 345. The attachment portion 345 includes one or more locking mechanisms 350, 355 for attachment to the gripping head 200. In one embodiment, one or more bolts 350 are used to attach the transport device 335 to the gripping head 200. To prevent the gripping members 230 from moving during transport or installation, one or more locking pins 355 may also be used. As illustrated in FIGS. 23-25, an arcuate profile 360 is formed on the exterior of the jaw body 265. The arcuate profile 360 is aligned with a hole 365 formed in the jaw block 240. The locking pin 355 may be inserted through the attachment portion 345, the hole 365 in the jaw block 240, and the arcuate profile 360 to prevent movement of the jaw body 265.

In operation, the gripping head 200 is installed in the rotary 220 using the transport device 335 as shown in FIGS. 19 and 20. Prior to installing, the gripping members 230 or jaws are individually set at the same length by rotating the shaft 260 or the jaw body 265. Once set, the indexing key 320 is inserted into the indexing slot 310 to ensure proper alignment of the dies 280. Thereafter, the transport device 335 is attached to the gripping head 200. To install the gripping head 200, the counter dovetail profile 272 of the shaft head 270 is mated with the dovetail profile of the respective connecting rod 212. Then the housing 225 is bolted to the rotary 220, and the transport device 335 is removed.

The powered gripping apparatus 215 may now be used to connect tubulars. Initially, a first tubular, such as a casing collar, may be inserted into the gripping head 200. A second tubular, such as a casing, may be retained by the backup gripping apparatus. Preferably, the backup gripping apparatus has an opening through a side of the body such the casing may be placed in the backup gripping apparatus without being inserted through longitudinally.

To connect the tubulars, the crank shaft is actuated to impart torque to the rotary 220. Initially, the stroke of the crank shaft causes the connecting rod 215 to extend radially. In turn, the gripping member 230 is moved radially into engagement with the casing collar. After the casing collar is engaged, the remainder of the stroke of the crank shaft rotates the rotary 220, which transfers the torque to the gripping head 200. As a result, the casing collar is rotated relative to the casing, thereby making up the tubulars.

Aspects of the present invention provide a gripping head 200 that can be quickly adjusted to accommodate a different sized tubular. To adjust the gripping head 200, the indexing key 320 is released from the indexing slot 310. Thereafter, the turn ring 292 is rotated to turn the gear ring 285 in order to extend or retract the gripping members 230 to the proper length. In the preferred embodiment, the jaw body 265 is rotated in 180 degree increments in order to align the dies 280 for engagement with the tubular. Because the connecting rods 212 are also able to move the gripping members 230 radially during operation, it is believed that only 180 degree increments are necessary to adjust the gripping member 230. When the dies 280 are not properly oriented due insufficient or over rotation of the gear ring 285, the indexing key 320 will not fit into the indexing slot 310. Once the dies 280 are properly oriented, the indexing key 320 is inserted into the indexing slot 310 to lock the adjustments made. In this manner, the gripping head 200 can be quickly adjusted to accommodate a different sized tubular. Therefore, aspects of the present invention provide an apparatus and method for simultaneously adjusting the gripping members 230 of a gripping apparatus for handling tubulars.

It must be noted that aspects of the present invention are equally applicable to other types of gripping apparatus known to a person of ordinary skill in the art. Particularly, aspects of the gripping head are applicable to a gripping apparatus having a plurality of gripping members or jaws. Suitable examples of gripping apparatus include those powered by a cylinder, a wedge, a crank shaft, and a chucking unit. Additionally, other types of dies or other material for engaging the tubular may be used without deviating from aspects of the present invention. Therefore, it is contemplated that tubular engaging devices without orientation requirements may be used with the present gripping members.

While the foregoing is directed to embodiments of the present invention, other and further embodiments of the invention may be devised without departing from the basic scope thereof, and the scope thereof is determined by the claims that follow.

1. An apparatus for handling a tubular, comprising:
a housing for receiving the tubular;
a plurality of gripping members disposed in the housing for gripping the tubular; and
a plurality of torque distributors disposed in the housing for engaging the plurality of gripping members.

2. The apparatus of claim 1, wherein the plurality of torque distributors prevents the plurality of gripping members from twisting as torque is applied to the tubular.

3. The apparatus of claim 2, wherein the plurality of torque distributors comprises a pin having an arcuate surface on one side and a flat surface on another.

4. The apparatus of claim 1, wherein the housing comprises a chamber for maintaining a respective gripping member.

5. The apparatus of claim 1, further comprising a load plate disposed between the plurality of gripping members and the housing.

6. The apparatus of claim 5, wherein a contact surface between the load plate and the plurality of gripping members comprises an arcuate surface.

7. The apparatus of claim 1, wherein the plurality of gripping members comprises a piston and cylinder assembly.

8. The apparatus of claim 7, wherein the piston is attached to the housing and the cylinder is radially movable relative to the piston.

9. The apparatus of claim 7, further comprising an engagement member disposed on the piston and cylinder assembly.

10. The apparatus of claim 9, wherein the engagement member is selected from the group consisting of a jaw, a die, and combinations thereof.

11. The apparatus of claim 7, wherein the plurality of torque distributors prevents the plurality of gripping members from twisting.

12. The apparatus of claim 7, wherein the plurality of torque distributors are disposed parallel to an axis of the piston and cylinder assembly.

13. The apparatus of claim 12, wherein a bending force acting on the piston and cylinder assembly is distributed across the plurality of torque distributors.

14. The apparatus of claim 12, wherein six torque distributors guides each gripping member.

15. An apparatus for handling a tubular having a first portion and a second portion, comprising:
a frame;
a first gripping apparatus disposed on the frame;
a second gripping apparatus disposed on the frame, wherein each of the gripping apparatus includes:
a housing for receiving the tubular;
a plurality of gripping members disposed in the housing for gripping the tubular; and
a plurality of torque distributors disposed in the housing for distributing forces acting on the plurality of gripping members.

16. The apparatus of claim 15, wherein the first gripping apparatus has torquing capability.

17. The apparatus of claim 15, wherein the second gripping apparatus includes one or more torquing members for rotating the housing.

18. The apparatus of claim 17, wherein the one or more torquing members comprise a piston and cylinder assembly.

19. The apparatus of claim 15, wherein the plurality of torque distributors prevents the plurality of gripping members from twisting.

20. The apparatus of claim 19, wherein each of the plurality of torque distributors has an arcuate surface on one side and a flat surface on another.

21. The apparatus of claim 19, further comprising a load plate disposed between the plurality of gripping members and the housing.

22. The apparatus of claim 21, wherein a contact surface between the load plate and the plurality of gripping members comprises an arcuate surface.

23. The apparatus of claim 15, wherein the plurality of gripping members comprises a piston and cylinder assembly.

24. The apparatus of claim 23, further comprising a tubular engagement member disposed on the piston and cylinder assembly.

25. The apparatus of claim 24, wherein the engagement member is selected from the group consisting of a jaw, a die, and combinations thereof.

26. The apparatus of claim 23, wherein the plurality of torque distributors prevents the plurality of gripping members from twisting.

27. An apparatus for handling a tubular, comprising:
a housing for receiving the tubular; and
a plurality of gripping members disposed in the housing for gripping the tubular; wherein the plurality of gripping members are adjusted to the size of the tubular.

28. The apparatus of claim 27, wherein the plurality of gripping members are adjusted simultaneously.

29. The apparatus of claim 28, wherein each of the plurality of gripping members comprises a shaft threadedly connected to a jaw body.

30. The apparatus of claim 27, wherein each of the plurality of gripping members comprises a shaft threadedly connected to a jaw body.

31. The apparatus of claim 30, wherein the jaw body comprises a gear profile disposed on an outer surface.

32. The apparatus of claim 30, wherein the plurality of gripping members are adjusted by engaging the gear profile.

33. The apparatus of claim 27, further comprising an indexing assembly for aligning one or more tubular engagement members.

34. The apparatus of claim 33, wherein the indexing assembly comprises an indexing key for mating with an indexing slot on the gripping member.

35. The apparatus of claim 27, wherein the plurality of gripping members are adjusted using a turn ring.

36. The apparatus of claim 35, further comprising one or more rollers to facilitate rotation of the turn ring.

37. The apparatus of claim 27, wherein the housing and the plurality of gripping members are disposed in a rotary.

38. The apparatus of claim 27, further comprising a transport device.

39. The apparatus of claim 38, further comprising a locking mechanism to prevent movement of the gripping members during transport.

40. The apparatus of claim 27, wherein the plurality of gripping members are adjusted mechanically.

41. The apparatus of claim 40, wherein the plurality of gripping members are adjusted using a gear ring.

42. A method for handling a tubular, comprising:
providing a gripping apparatus having a plurality of gripping members;
adjusting the plurality of gripping members to accommodate the tubular;
gripping the tubular; and
applying torque to rotate the tubular.

43. The method of claim 42, wherein adjusting the plurality of gripping members comprises adjusting the plurality of gripping members simultaneously.

44. The method of claim 42, wherein the plurality of gripping members are adjusted hydraulically.

45. The method of claim 42, wherein the plurality of gripping members are adjusted mechanically.

46. The method of claim 42, wherein the gripping members comprise a shaft and a jaw body, wherein the jaw body is rotatable relative to the shaft.

47. The method of claim 46, wherein the plurality of gripping members are adjusted by rotating the jaw body relative to the shaft.

48. The method of claim 47, wherein the jaw bodies of the plurality of gripping members are rotated using a turn ring.

49. The method of claim 42, further comprising orienting the plurality of gripping members using an indexing system.

50. The method of claim 49, wherein the indexing system comprises an indexing key and an indexing slot formed on the plurality of gripping members.

51. The method of claim 50, wherein two indexing slots are formed at opposite sides of the plurality of gripping member.

52. The method of claim 51, wherein the plurality of gripping members are adjusted at 180 degree increments.

53. A suspension unit for retaining a spinner to connect tubulars, comprising:
one or more levers for coupling to the suspension unit to the spinner, wherein the spinner is allowed to move freely to align the tubulars during makeup.

54. The suspension unit of claim 53, wherein the suspension unit is adapted equalize the reaction torque transferred from the spinner.

55. The suspension unit of claim 53, further comprising a vertical lever for compensating for a weight of the spinner.

56. The suspension unit of claim 53, further comprising a load indicator for measuring a weight of the spinner.

57. The suspension unit of claim 53 further comprising an extension member for accommodating a change in length during make up.
